(19) United States
(12) Patent Application Publication
(10) Pub. No.: US 2013/0000462 A1
(43) Pub. Date: Jan. 3, 2013

(54) GRAPHICAL TEACHING DEVICE

(76) Inventors: David A. Freiberg, Golden Valley, MN (US); Lisa A. Berman, Eden Prairie, MN (US)

(21) Appl. No.: 13/538,465

(22) Filed: Jun. 29, 2012

Related U.S. Application Data
(60) Provisional application No. 61/571,606, filed on Jun. 30, 2011.

(51) Int. Cl. G09B 15/02

(52) U.S. Cl. 84/477 R

(57) ABSTRACT

A device comprises a first image phase with a first set of coded indicia positioned with respect to a background image, a second image phase with a second set of coded indicia positioned with respect to the background image, and means to alternate between the first and second phases. The second set of coded indicia are related to the first set of coded indicia by a mapping based on the background image, and means are provided to alternate between the image phases, the means configured to select the background image with the first set of coded indicia or the background image with the second set of coded indicia.

### CROSS-REFERENCE TO RELATED APPLICATIONS

This application claims priority to U.S. Provisional Application Serial No. 61/571,606, filed Jun. 30, 2011, the entirety of which is incorporated herein by reference.

### FIELD OF THE INVENTION

This invention relates to a graphical teaching device with a means to simultaneously alternate between multiple images that contain related but distinct information. A preferred embodiment of the invention finds utility for instructing finger positions on musical instruments wherein the invention simultaneously indicates on a fingerboard image the finger position of musical notes on a musical staff and the finger position of the corresponding musical letter name.

### BACKGROUND OF THE INVENTION

Most students who learn to play the violin struggle with note reading. This is because violin, unlike piano, is not a push button, keyed, or fretted instrument. In fact there are no distinguishing marks, frets, or keys to tell a violinist where to put his or her fingers. To make matters more challenging, the tuning of the instrument in fifths, a traditional method of tuning because each string is separated by five notes or “fifths” on the musical scale, means that a finger placed in the same spot on an adjacent string may be a flatted, natural or sharped note and it requires an extensive knowledge of theory far beyond the needs of the beginner to understand why the notes on the violin are arranged as they are.

In the end the student may simply need to memorize where a given note is located on the violin, rather than looking for some logical way of figuring it out as he or she goes along. Further, the lack of frets or buttons means that even if a student knows exactly what note to play and what finger should play that note, there is no guarantee that the note will be in tune.

Students of music need to learn the intricacies of scales, chords, and progressions and associated fingerings, as they are the basis of musical theory. There is a need for a device to assist students in visually learning these components of music. Teaching methods, such as Sevcik, Suzuki, and Barbara Barber rely on arranging music in increasing order of difficulty as the sole or primary means of instruction. The prior art has attempted to satisfy the need for learning notes, scales, and finger positioning with various devices.

U.S. Pat. No. 6,323,410 to Rackow discloses a musical slide rule with a base listing two sets of musical notes arranged in two columns. The cover has apertures on each side and is slidable on the base. Aligning the apertures of the cover with the musical note symbol gives the user information regarding that note. There are several other similar inventions that use a sliding cover and base in either a linear or circular format to display musical information. Examples are U.S. Pat. No. 4,960,029 to Nelson, U.S. Pat. No. 4,677,893 to Fahnestock, U.S. Pat. No. 3,592,099 to Gibby, U.S. Pat. No. 2,832,252 to Gabriel, and U.S. Pat. No. 3,791,254 to Muller.

U.S. Pat. No. 5,644,096 to Bull discloses a musical computation device that provides the alphabetic representation of notes, a representation of a keyboard, a representation of finger positions on an instrument, and an accepted musical notation.

Lenticular Printing is a method by which normally flat, static images can convey depth and motion. The image is an optical illusion created by a plastic sheet covered with many rows of tiny lenses. Such devices are well known in the art and are described in detail in U.S. Pat. No. 3,538,632, the disclosure to which is incorporated herein entirely by reference and U.S. Pat. No. 4,541,727, the disclosure to which is incorporated herein entirely by reference.

Besides the plastic sheet containing a multitude of lenses (or components of a lens system), the other ingredient in lenticular printing is the image layer mated to the lens. An image must be specially prepared to match the lens. This image usually starts as multiple images. These images are interlaced together; that is, they are sliced up into strips and blended together into one image. The size of these strips is determined by the lenticular lens that will be used, and the resolution of the printing device.

Each lens on the lenticular sheet magnifies a small portion of the image beneath it. As the viewing angle of the lens changes, a different portion of the image is magnified. That is why lenticular images appear to change as the viewing angle changes.

This effect can be a simple flip between two images or show several frames of motion. By turning the lenticular lenses vertically, each eye can be shown a different copy of an image resulting in a three dimensional (3D) image. 3D effects can typically be achieved only in a side to side (left to right) direction, as the viewer's left eye needs to be seeing from a slightly different angle than the right to achieve the stereoscopic effect. Other affects, like morphs, motion, and zooms work better (less ghosting or latent effects) as top-to-bottom effects, but can be achieved in both directions.

### SUMMARY OF THE INVENTION

This invention relates to a graphical teaching device with a means to nearly simultaneously alternate between multiple images that contain related but distinct information. While it is envisioned that such graphical teaching devices may find utility in a multitude of applications, a preferred embodiment relates to a graphical teaching device for learning music. The invention incorporates the novel capabilities of lenticular imaging, and is more than a diagram or graph. It incorporates a two-dimensional representation of a three-dimensional fingerboard or keyboard with a perceived metamorphosis from one phase (notes in letter notation) to a second phase (notes on a staff). Because the student can see quickly and repeatedly both phases, the association between them is learned more quickly and indelibly.

The invention comprises a graphical teaching aid for learning the connection between musical notes on a staff and their corresponding letter names. Phase one depicts a graphical representation of the fingerboard of an instrument with all the fingered notes in their letter notation. Phase Two shows corresponding notes in their finger position as notes on the staff. By tilting or moving the chart, relative to the viewer's position, the chart switches from Phase one to Phase two. The two images of fingerboard phases are produced by lenticular printing, the method by which normally flat, static images convey depth and motion. When the various images are collected, they are flattened into individual, different frame files, and then digitally combined into a single final file in an interlacing process. The printing shows a set of alternate images which appear to transform into each other. This teaching aid intuitively facilitates learning musical notes by their position on a musical staff, their letter name, and the finger position on the instrument.

The invention encompasses a graphical teaching device with a means to alternate between a multitude of phases to depict in a near simultaneous fashion a plurality of instructional graphs or charts. A preferred embodiment of this unique graphical aid finds utility for teaching and learning the connection between musical notes on a staff and their corresponding letter names as well as where the notes/letter names are located on the musical instrument. The teaching aid simultaneously combines different but related aspects from multiple graphs into one easy to comprehend presentation.

Various embodiments of the invention include, but are not limited to: a graphical teaching device with a means to alternate between a multitude of phases to depict in a near simultaneous fashion a multitude of graphs or charts; and, a graphical teaching device for musical instruments with a means to alternate between finger position of musical notes on a musical staff and finger position of the corresponding musical letter name. Additional embodiments include, but are not limited to: a method of teaching musical notes that uses a graphical musical teaching device.

Any of the forgoing embodiments may be provided in any combination, wherein: the musical instrument is a keyboard instrument; the musical instrument is a fretted instrument; and, the musical instrument is a stringed instrument. Additional embodiments may also be provided, wherein: the stringed musical instrument is a violin; the means to alternate is accomplished with a lenticular process; and, the means to alternate is accomplished with a digital animation process.

In various additional embodiments of the invention, an alternating-image device has a first and second image phases with first and second sets of coded indicia positioned with respect to a background image. The sets of indicia are related by a mapping based on the background image, and means are provided to alternate between the first and second image phases in order to select the background image with the first or second set of indicia. The mapping may be one-to-one and onto, and the image alternating means may comprise a lenticular lens superposed over the images, configured to select between the sets of indicia based on viewing position with respect to the device.

In any of the foregoing embodiments, the background image may represent finger positions on a musical instrument, and the indicia may represent musical notes corresponding to the finger positions. The first set of indicia may comprise alphanumeric characters representing the notes, and the second set may represent corresponding staff positions, for example with a mapping based on a key or clef of the musical instrument. The background image may also represent a fretless fingerboard or fretboard, or a keyboard where the sets of indicia represent staff positions mapped to musical notes corresponding to finger or playing positions on the keyboard.

In additional embodiments, a lenticular imaging device includes an image representing playing positions on a musical instrument, with first and second sets of coded indicia representing musical notes corresponding to the playing positions and staff positions corresponding to the musical notes, respectively. A lenticular system may be positioned over the image, where the lenticular system is configured for selecting between views of the first and second sets of indicia with respect to the playing positions, and where the notes are mapped onto the staff positions based on a key or clef of the musical instrument. The image may represent finger positions on a fingerboard, and the fingerboard may be fretless to represent an instrument in the violin family. The image may also represent a key or bar layout, where the musical notes are mapped to the staff positions based on the key or layout.

In additional embodiments, a graphical teaching device comprises a first image comprising alphanumeric indicia identifying musical notes corresponding to finger positions on a musical instrument, and a second image comprising staff indicia identifying the musical notes corresponding to the finger positions, where the musical notes are mapped one-to-one onto the staff indicia based on a key or clef of the musical instrument. An imaging system for selecting between the first and second images may be provided. The images may represent finger positions in perspective on a fretless fingerboard or fretboard, and may include markers to show tape locations. The images may also represent finger positions on a keyboard. The imaging system may comprise a lenticular array configured for selecting between the first and second images based on viewing angle.

### BRIEF DESCRIPTION OF THE DRAWINGS

FIG. 1 shows an example of one (first) image phase depicting the finger position and musical letter associated with each note for a stringed instrument, for example a violin.

FIG. 2 shows an example of another (second) image phase depicting the finger position and musical note on a treble clef staff associated with each note for the stringed instrument.

FIG. 3 is an illustration of a lenticular device for alternating between first and second images or image phases, in a graphical teaching device configured for musical instruments.

FIG. 4 is an illustration of an alternate first image phase for a lenticular teaching device, showing alphanumeric indicia identifying musical notes corresponding to finger positions on a keyboard.

FIG. 5 is an illustration of an alternate second image phase for the teaching device, showing staff positions corresponding to the musical notes.

FIG. 6 is an illustration of a teaching method using an alternating-image device.

### DETAILED DESCRIPTION OF THE INVENTION

This invention comprises a graphical teaching aid for learning the connection between musical notes on a staff and their corresponding letter names. Phase one depicts a graphical representation of the fingerboard of an instrument with all the fingered notes in their letter notation. Phase two shows corresponding notes in their finger position as notes on the staff. By tilting or moving the chart, relative to the viewer's position, the chart switches from phase one to phase two. The relative motion may easily be effected by a user moving his/her head relative to a stationary lenticular sheet, e.g., one placed on a music stand or holder in front of the user, who uses both hands to finger and/or hold an instrument on which the musical notes are to be played.

The two images of fingerboard phases are produced by lenticular printing, the method by which normally flat, static images convey depth and motion. When the various images are collected, they are flattened into individual, different frame files, and then digitally combined into a single final file in an interlacing process. The printing shows a set of alternate images which appear to transform into each other. This teaching aid intuitively facilitates learning musical notes by their position on a musical staff, their letter name, and the finger position on the instrument.

The invention, used with or without the accompanying method book described below, teaches students how to quickly and easily read notes by using a diagram of the fingerboard which indicates four things: the name of the note; the finger that plays the note; where that finger should be placed; and, what the corresponding note on the staff looks like. To date, there is no way to present all of this information at once in a way it can be read and interpreted quickly and easily. However, the invention uses a fingerboard shaped image with perspective and a unique description of finger position using forward and back rather than high and low so that information can be extracted by the student with ease.

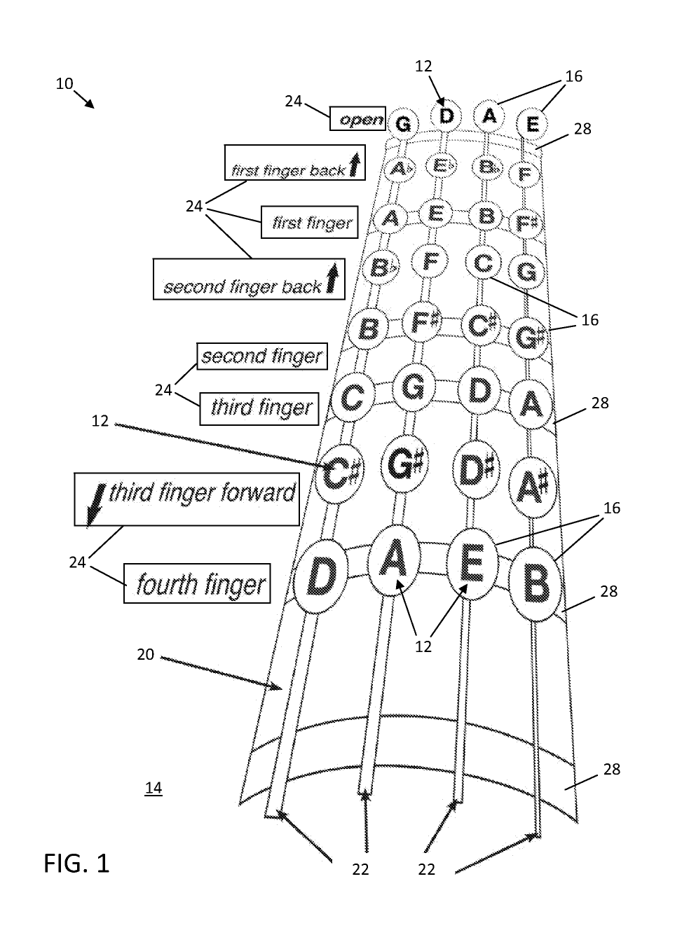

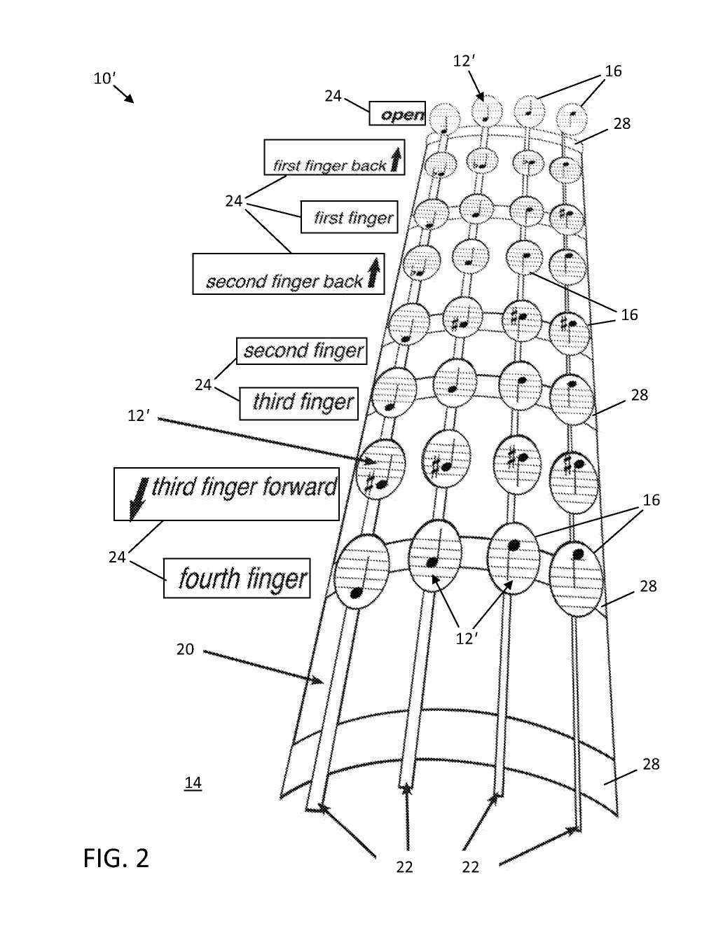

Using lenticular printing, the invention presents both the name of the note (e.g., FIG. 1) and an image of how that note looks on the staff (e.g., FIG. 2), in effect simultaneously. The student therefore can look from his music to the diagram to figure out finger placement. And, with a little practice, he or she can use this tool to read music and at the same time memorize the notes.

In field tests, students who struggled with note reading using other methods were comfortable with reading notes remarkably quickly. They also learned to distinguish easily between what is traditionally called first, second, or third finger high or low (corresponding in our diagram to first, second or third finger forward or back) versus first, second, or third finger high or “on the tapes.”

Ordinarily, these distinctions are a challenge that can take years to address. Another reason this system works is that the diagram is labeled with colored stripes that correspond to the customary placement of mechanical tapes on the violin—thus meeting curricular expectations of the teacher and fitting within a system already widely used.

Potential applications beyond the private studio include use by youth orchestras or public school orchestras, where students can place the diagram on their music stands to enhance their ability to read and play the music. The opacity of the diagram (in one embodiment) allows it to be read even when placed on top of sheet music or text. Another improvement over the prior art is that the diagram is labeled with colored stripes that correspond to the placement of mechanical tapes on the violin, and thus meets the curricular expectations.

Although originally developed for violin, it is envisioned that this invention can be applied to other musical instruments, with certain logical modifications, for example keyboard instruments including but not limited to piano, organ, marimba, and xylophone. Rather than describing fingers as high or low, as traditionally taught, our design focuses on the literal motion and directionality of the fingers. On the piano, this motion could be side to side (i.e., from left to right or right to left), and thus “forward and back” could be replaced with similarly appropriate directional labeling. Additionally, piano uses both treble clef and bass clef, while violin uses only treble clef. Thus, on the piano, two octaves could be an ideal layout.

Fretted instruments, including but not limited to, guitar, bass guitar, mandolin, and banjo, could require labeling of frets and fret markers, for example up to the 12^{th} fret, which encompasses one octave as well as placement of notes in between frets. Similar modifications to directional labeling could also be necessary. Other stringed instruments, including viola, cello and bass, could require minimal modification of the violin diagram.

Although these diagrams could work for any sheet music, due to the existence of enharmonic notes and keys a method book that includes only the notes found on the diagram can make note reading occur faster. Further, dividing this method book into sections that introduce new notes gradually and linked to the labeling of finger positions on the diagram yields enhancements not only in note reading, but also in a student's pitch and finger accuracy. This is partly due to the psychological theory of chunking, whereby people memorize faster when they divide something large into smaller sections and repeat those smaller sections for an extended period of time before progressing to new ones.

Additionally, repetition of the same notes rather than their enharmonic variants allows the student to begin to recognize how each note sounds based on the theory of tonal music that underlies almost everything we hear, from children's songs to the most recent pop hit on the radio. For this reason, selection of keys in the method book is based on an understanding of how notes fit and play distinctive roles in our tonal system.

For example, the leading tone, or 7^{th} degree of a major scale, has an exceptionally recognizable quality. In the method book, because finger positions correspond to notes and there are no enharmonics, a student learns how the leading tone sounds as it moves to the root of the tonic chord through repetition of this note functioning in an identical way throughout the book. The movement of the leading tone to the root of the scale duplicates the V-I progression that is a foundation of our modern tonal system. This gives students using this method book, combined with the lenticular diagram, an advantage not only in note reading but also in their development of pitch and harmony.

Finally, use of songs that are either familiar or strongly diatonic, along with inclusion of lyrics, where applicable, further speeds learning. And, while the majority of method books use simplified versions of familiar songs, our method book meets the expectation of the student for song familiarity. This is achieved through appropriate editing and key selection. Hence, a familiar version of the song actually becomes easier to play than a version arbitrarily modified to avoid certain notes or rhythms. This, also, speeds learning of notes and pitch.

This system represents an advance in the teaching of music in that it helps teach several of the most challenging concepts, accurate pitch, harmony, and note reading, faster than other methods available to date. In our tests, students have learned note reading in a matter of days to weeks, and have been able to learn the specific notes in an individual song in a matter of minutes.

Further, an early and solid foundation in note reading and pitch prepares the student for understanding more advanced theoretical concepts such as key signatures, scales, and harmony. These advantages could apply to any instrument where a lenticular diagram was used along with a similarly prepared method book. Another advantage is that removal of what is usually a large hurdle for students frees the teacher to focus on technique, phrasing, expression, rhythm, and overall proficiency on the instrument.

It is also envisioned that this invention can be made available as a digital application in animation form to be used on computers and wireless mobile devices. The user can switch from one mode to another by means of a graphical switch, or the application will switch automatically at programmable intervals.

It is envisioned that this invention will find utility as a graphical teaching device in fields other than music. The invention permits the near simultaneous presentation of two graphs or charts into one image. This combining or overlay will find utility when a multitude of information must be related to show different aspects of the same thing.

Examples of other (non-musical) applications for lenticular diagrams include medical anatomy illustrations and pathology, for example, a teaching aid regarding human anatomy, which could incorporate the skeletal, muscular, and circulatory structure. To show a specific relationship of one system to another from one flip or image selection to the other, e.g., flip (or image) #1: the nervous system of the hand; flip (or image) #2: the muscles and tendons of that hand. Additional examples could show the growth or reduction of a malignant mass in part of the body, joint degeneration to replacement with an artificial joint, venous and arterial blood flow in an organ (kidney, liver, or brain), or how leads from an implanted medical device are inserted.

Mechanical, electrical, and electronic systems, electronic devices and schematic diagrams could show, from one flip or image selection to the other, an HVAC system and a plumbing system in a building's architectural plans, layers in a printed circuit board or integrated circuit, detail of a map's topography with highways, a molecular schematic of a chemical reaction, before and after landscaping projects, different modes in a control system display, and computer key commands and their specific actions. Automotive applications include repair steps, e.g. for hydraulic systems in disc brakes, or one or more probable false diagnoses (image 1), as compared to corresponding correct diagnoses (image 2), on a background showing the mechanical system of interest, with optional indicators, conditions or symptoms.

Language-based applications include systems, devices and methods for learning American Sign Language (ASL), showing, from one flip (or image selection) to another, a letter or word and the corresponding correct ASL (or similar foreign sign language) hand signal or sign. Other language-based applications include systems, devices and methods for learning spoken languages, for example showing a word in one language, (e.g., English “you”), and alternating between indicia representing different forms of the word in another language (e.g., formal “vous” and informal “tu” in French, or singular and plural forms). Alternatively, the background could show an image corresponding to a word, and the indicia could represent the image in different languages.

FIG. 1 is a schematic illustration showing first image phase (or image) 10 for an alternating-image device, for example a graphical teaching device for a stringed musical instrument such as a violin. Image phase 10 includes a set of coded indicia 12 positioned with respect to background image 14, for example with indicia 12 representing alphanumeric musical notes corresponding to finger positions 16 on fingerboard 20.

In the particular example of FIG. 1, fingerboard 20 is of a fretless design, with four strings (or string indicators) 22 and eight different finger positions 16 distributed along each string 22. Fingerboard 20 is shown in perspective, proceeding or larger toward the front and bottom, proximate the user or musician, and receding or smaller toward the back and top, away from the user or musician.

Alphanumeric character-based indicia 12 encompass upper and lower case letters, numbers and other symbols representing musical notes, including, but not limited to, A, B, C, D, E, F, G, sharps (♭), flats (♯), and naturals (♮). Background image 14 may also include one or more additional features, such position labels 24 to identify finger positions 16 along strings 22, and markers or stripes 28 to show the locations of marking tapes or other teaching devices for use with fretless fingerboard 20.

In fretless configurations, fingerboard 20 may represent a bowed string instrument in the violin family, such as a violin (or fiddle), viola, cello (violoncello) or contrabass (double bass). Alternatively, fingerboard 20 may represent the fingerboard of a strummed or plucked string instrument such as a fretless (e.g., bass) guitar or fretless banjo. In other designs, markers 28 may indicate fret positions for a fretted fingerboard or fretboard 20, for example a fretboard for a guitar, mandolin, fretted banjo, dobro or balalaika. In each of the designs, the number of strings 22 and finger positions 16 vary accordingly, as does the tuning configuration relating finger positions 16 to the musical notes represented by coded indicia 12.

FIG. 2 is a schematic illustration showing second image phase (or image) 10′ for the alternating-image device, corresponding to first image phase 10 of FIG. 1, above. As shown in FIG. 2, a second set of coded indicia 12′ are positioned with respect to background image 14, for example to represent the staff positions corresponding to the musical notes produced at different finger positions 16.

Second set of indicia 12′ are related to first set 12 by a mapping based on background image 14. For example, indicia 12′ may represent note positions on a treble clef staff, as shown in FIG. 2, corresponding to the musical tones produced at finger positions 16 for a violin family-type fingerboard 20, shown in FIG. 1.

Generally speaking, there may be a one-to-one mapping from first set of indicia 12 onto second set of indicia 12′ (and vice-versa). For example, alphanumeric character indicia 12 may be mapped one-to-one onto particular treble or G-clef staff position indicia 12′, as shown for the violin tuning configuration of fingerboard 20 in FIGS. 1 and 2. Alternatively, alphanumeric character indicia 12 may be mapped onto bass or F-clef indicia 12′, for example in a double bass or contrabass configuration of fingerboard 20. In additional configurations, a combination of treble and bass clefs may be used, along with other configurations including, but not limited to, soprano, sub-soprano, alto, tenor, baritone, sub-bass and French violin clef representations, and combinations thereof.

The relationship or mapping between sets of indicia 12 and 12′ and playing positions 16 thus depends on the type and tuning characteristics of the musical instrument represented by fingerboard 20. In violin-family instruments, for example, four strings 22 are commonly tuned in intervals of perfect fifths, as shown in FIG. 1, but three-string, five-string, six-string and other configurations are also known, both in the violin family and in related instruments such as the viol (or viol de gamba), and in plucked instruments such as the guitar. In these alternative configurations, strings 22 may be tuned in thirds, fourths, fifths and combinations thereof, or using an alternative tuning configuration such as a dropped guitar or scordatura (alternative classical) tuning style.

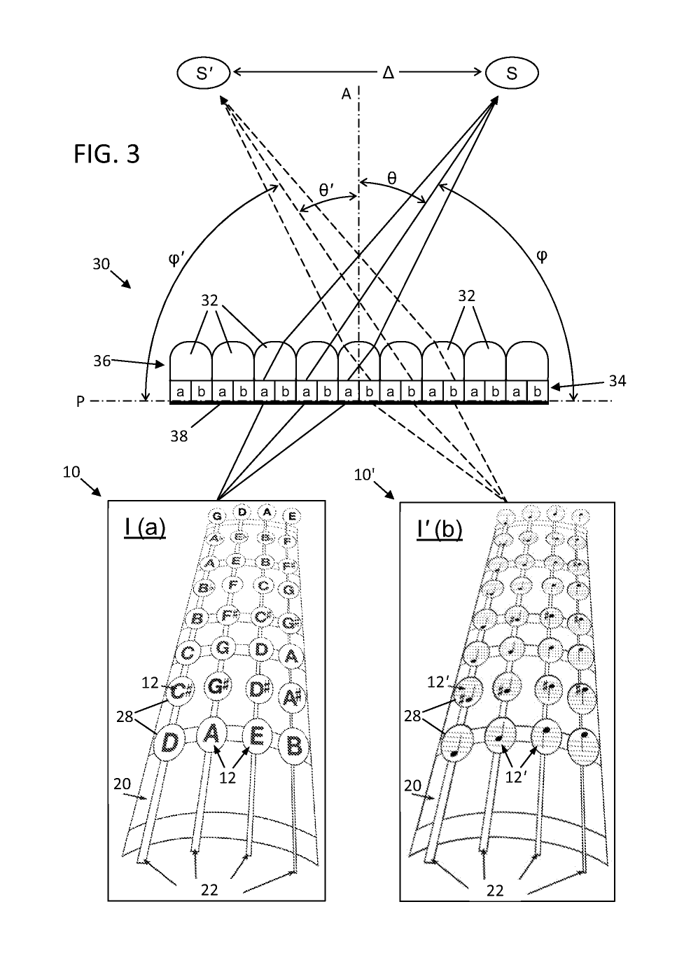

FIG. 3 is an illustration of lenticular (or alternating-image) device 30 for alternating between first and second images (or image phases) I(a) and I′(b), for example between image phases 10 and 10′ of FIGS. 1 and 2, above, as observed at relative positions S and S′. Viewing positions S and S′ are defined at angles φ and φ′ with respect plane P of lenticular device 30, respectively. Alternatively, viewing positions S and S′ may be defined at (complementary) angles 0 and 0′ with respect to vertical axis A of lenticular device 30, where vertical axis A is perpendicular to medium plane P.

As shown in FIG. 3, lenticular device 30 includes a series of individual lens elements 32, which are positioned or superposed over first and second image elements a and b of images I(a) and I′(b) to select between image phases 10 and 10′ at viewing positions S and S′, respectively. In one design, for example, complementary images I(a) and I′(b) including both indicia 12 and 12′ and background 14 are divided into a number of vertical (or horizontal) strip elements a and b, respectively, which are alternated along medium plane P in medium layer 34 of lenticular device 30.

Background 14 may also be provided on a separate medium backer layer 38, with indicia 12 and 12′ provided in the faun of transparent overlays and divided into individual (e.g., vertical or horizontally divided) image elements a and b. Alternatively, backer layer (or backer) 38 may be provide opaqueness or color properties, or may include structural materials to improve durability and performance of device 30.

Lenticular lens array (or lens system) 36 is formed with individual lens elements 32 positioned above individual image elements a and b, in order to select between image phases 10 and 10′ at viewing positions S and S′, respectively. In graphical teaching system applications of lenticular device 30, a user may thus select between alphanumeric note indicia 12 and staff indicia 12′ by adjusting the viewing angle, for example by a slight head reposition or by tilting device 30 up or down, or left to right. Alternatively, coded indicia 12 and 12′ represent different markings on alternate backgrounds 14, for example anatomical markings in a circulatory or organ system for anatomical study, or HVAC, electrical, and plumbing indicia in a building design application, as described above.

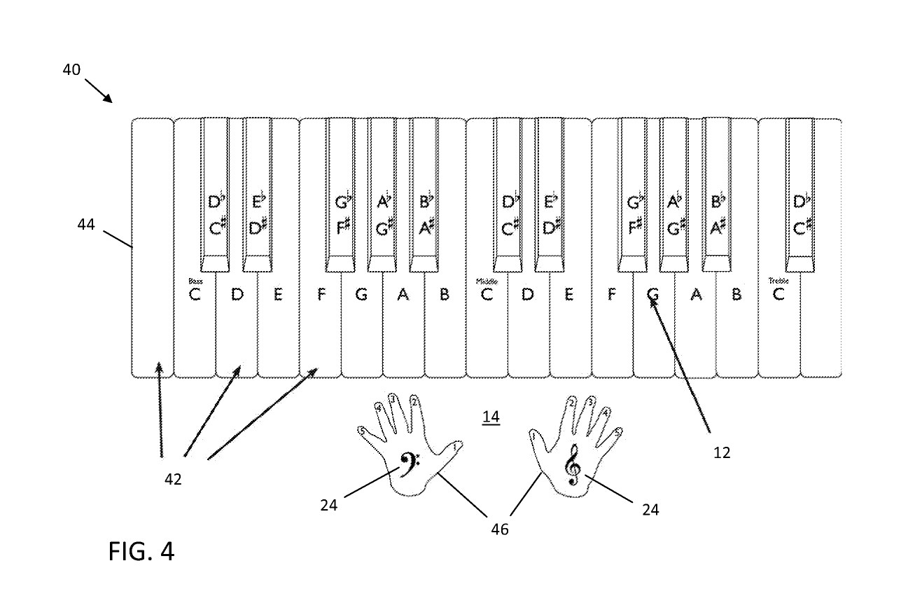

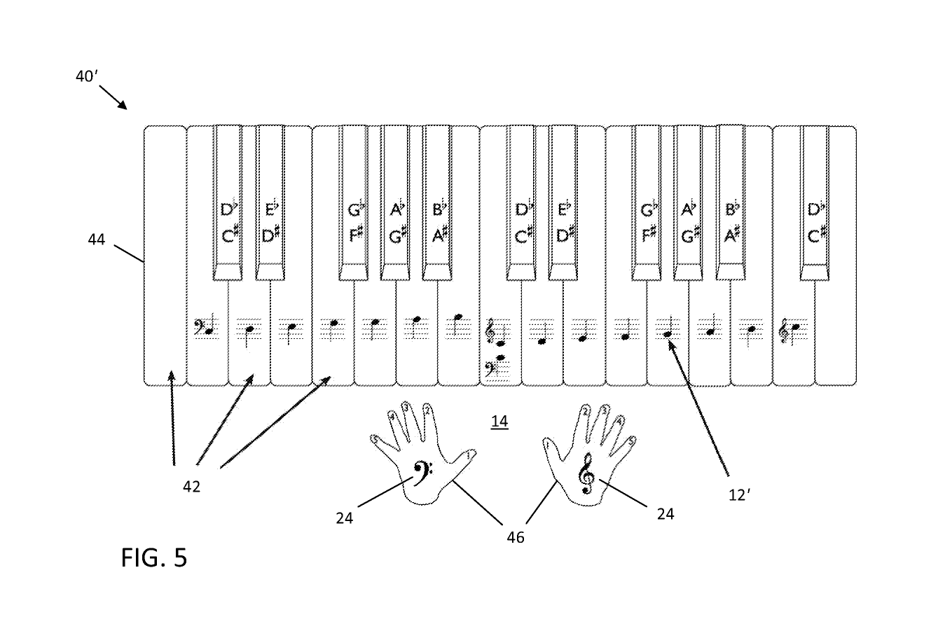

Thus, first and second images (or image phases) 10 and 10′ provide sets of coded indicia related by a mapping based on position with respect to background image 14. In this particular example, background image 14 includes fingerboard or fretboard 20. Image phases 40 and 40′ of FIGS. 4 and 5 provide corresponding structure and function for a different background image 14, for example a keyboard, as described below.

Device 30 also provides means to alternate between the image phases to select background 14 with first or second set 12 or 12′ of coded indicia based on viewing positions S and S′. For example, device 30 may provide image-alternating lenticular lens system 36 positioned over medium layer 34, as described above, with first and second image phases 10 and 10′ (or 40 and 40′) built up from individual image elements (a) and (b) of corresponding images I(a) and I′(b).

In lenticular configurations, selection between images I(a) and I′(b) may achieved by repositioning the head or eye position, for example by shifting weight from one leg or one side to another, or by turning or tilting the head, in order to shift between observer or viewing positions S and S′. Alternatively, the shift may achieved by tilting or repositioning device 30 with respect to the observer, or by a combination of changes in the position or orientation of device 30 with respect to viewing position (or observer position) S or S′.

The degree of shift depends upon a number of factors, including viewing distance and the configuration of individual lenticular elements 32, and may range from about 1-2°, about 2-5°, about 5-10° or more between viewing angle φ (or θ) and angle φ′ (or θ′). Depending on observer position, this may correspond to a shift (Δ) in between viewing positions S and S′ of about 1-2 inches, about 2-4 inches, about 3-6 inches, or more or less. Alternatively, a video switch or other mechanical or electromechanical image switching means may be provided.

In musical applications, background image 14 represents finger or playing positions 16 on a musical instrument, and coded indicia 12 and 12′ represent corresponding musical notes. For example, the first set of indicia may represent the notes with alphanumeric characters, and the second set may represent the notes with staff positions. In this configuration, the alphanumeric characters can be mapped to the staff positions based on the key or clef of the musical instrument, as shown in FIG. 3.

Where background image 14 represents a stringed instrument, the mapping between first and second sets of indicia 12 and 12′ may correspond to finger positions 16 on fingerboard 20, which in turn may depend upon the tuning of strings 22. In these applications, fingerboard 20 may be fretless, or may represent a fretboard 20 on a guitar or other fretted instrument.

In these applications where the shift between image I(a) and I′(b) (or indicia 12 and 12′) is achieved by a change in viewing angle, it is possible to turn the head to accommodate the change or to substantially maintain a particular head position while shifting the viewing angle, for example by turning or refocusing the eyes. Thus, alternating-image device 30 also provides for a selection between alternate images I(a) and I′(b) while substantially maintaining a user or student (e.g., student musician) position with respect to an instrument, for example a particular head or body position with respect to a violin, cello, bass, guitar, or keyboard instrument.

This provides for substantially different learning experience, as compared to other designs, for example where two images I(a) and I′(b) or sets of indicia 12 and 12′ are provided together, without image selection, or where the user turns a card or performs another manual operation to change from one image to another, and where such a manual operation requires repositioning of the instrument. Depending upon viewing positions, device 30 may also provide for switching between images I(a) and I′(b) with selective processing of coding indicia 12 and 12′ in relatively greater or lesser degree by the right or left eye, where such selection can also modify the learning experience and provide additional benefits, either conscious or unconscious.

FIG. 4 is an illustration of alternate image phase (or image) 40 for lenticular (alternating-image) teaching device 30 of FIG. 3, corresponding to first image phase 10 of FIG. 1, above. In this particular application, alphanumeric indicia 12 identify the musical notes or tones corresponding to finger positions on keys 42 of keyboard or (keyboard instrument) 44, for example a piano, organ, harpsichord, synthesizer or other keyboard instrument. Alternatively, background 14 may represent a mallet or percussion instrument such as a marimba, xylophone, glockenspiel or vibraphone (vibes), with keyboard 44 representing the key or bar layout, and with indicia 12 indicating the notes corresponding to finger, hand or mallet (playing) positions when striking individual keys, bars, resonators or other sounding elements 42.

FIG. 5 is an illustration of another alternate image phase (or image) 40′ for the lenticular (alternating-image) teaching device 30, complementary to image phase 40 of FIG. 4 and corresponding to second image phase 10′ of FIG. 2, above. In the particular configuration of FIG. 5, staff position indicia 12′ identify musical notes corresponding to finger or playing positions on individual keys or bars 42 of keyboard or bar layout 44. Staff position indicia 12′ are mapped to alphanumeric indicia 12 based on the layout of background 14, including the particular arrangement of individual keys or bars 42.

In keyboard and other percussion applications, background (or background image) 14 may thus represent either a keyboard or an actual set of keys or bars. In addition, the mapping between coded sets of indicia 12 and 12′ may be based either on the musical notes corresponding to finger positions on the keyboard, or based on mallet or hand positions when striking individual keys or bars. In each of these applications, background 14 may also include additional labels or teaching markers 24 as adapted to a keyboard-type environment, for example the bass and treble clef assignments of (left and right) hands 46, respectively.

Alternatively, background 14 may provide other coding information related to the mapping between first and second sets of indicia 12 and 12′. For example, background 14 may represent an anatomical chart for applications of biological indicia 12 and 12′, or a blueprint for engineering applications, as described above.

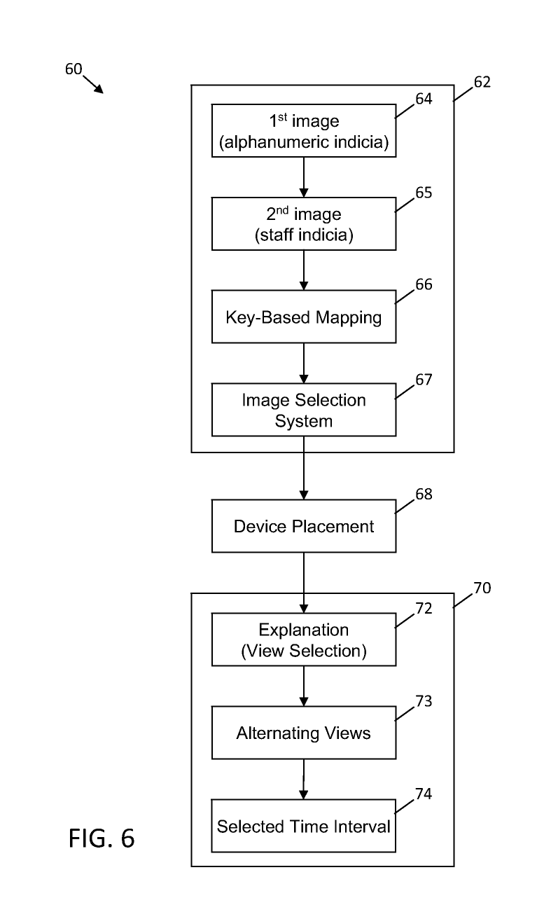

FIG. 6 is a block diagram that illustrates method 60 of using lenticular (alternating-image) teaching device 30 to teach music. Method 60 comprises providing a device (step 62) with: a first image comprising alphanumeric indicia identifying musical notes corresponding to finger positions on the musical instrument (reference 64); a second image comprising staff indicia identifying the musical notes corresponding to the finger positions (reference 65), wherein the musical notes are mapped one-to-one onto the staff indicia based on a key of the musical instrument (reference 66); and an imaging system for selecting between the first image with the alphanumeric indicia identifying the musical notes with respect to the finger positions and the second image with the staff indicia identifying the musical notes with respect to the finger positions (reference 67).

By placing the device in front of a pupil (step 68) and explaining (step 70) how the images may be selected by head position or viewing angle (reference 72), the teacher may cause the pupil to selectively and alternatingly view at close time intervals the first image and the second image (reference 73). The pupil may accomplish this with head movements only, or by shifting weight to adjust the head position, as described above, while keeping both hands on an instrument.

Referring to FIG. 3, the student can be instructed to select viewing position S or S′, thereby viewing selectively either of complementary images I(a) and I′(b). The close time intervals may be as brief as a 0.5-1.0 seconds or less or may be an interval of 1 to 30 seconds, or more, depending on the student, musical instrument, and teaching approach. In fact, the pupil can be encouraged to select a time interval (reference 74) that fits his/her learning style for learning the mapping of the different but corresponding indicia.

In the foregoing description, various embodiments of the invention have been presented for the purpose of illustration and description. They are not intended to be exhaustive, or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention, as determined by the appended claims, and when interpreted in accordance with the breadth to which they are fairly, legally, and equitably entitled.

1. A device comprising:
a first image phase comprising a first set of coded indicia positioned with respect to a background image;
a second image phase comprising a second set of coded indicia positioned with respect to the background image, the second set of coded indicia related to the first set of coded indicia by a mapping based on the background image;
means to alternate between the first image phase and the second image phase, the means configured to select the background image with the first set of coded indicia or the background image with the second set of coded indicia.

2. The device of claim 1, wherein means to alternate between the first image phase and the second image phase comprise a lenticular lens system superposed over the first and second images.

3. The device of claim 1, wherein means to alternate between the first image phase and the second image phase are configured to select the first set of coded indicia or the second set of coded indicia based on a viewing position with respect to the device.

4. The device of claim 1, wherein the mapping relating the second set of coded indicia to the first set of coded indicia is one-to-one and onto.

5. The device of claim 1, wherein the background image comprises a representation of finger positions on strings of a musical instrument and the first and second sets of coded indicia represent musical notes corresponding to the finger positions on the strings of the musical instrument.

6. The device of claim 5, wherein the first set of coded indicia comprise alphanumeric characters representing the musical notes and the second set of coded indicia comprise staff positions representing the musical notes.

7. The device of claim 6, wherein the alphanumeric characters are mapped to the staff positions based on a key or clef corresponding to the musical instrument.

8. The device of claim 1, wherein the background image comprises a representation of a fingerboard and the sets of coded indicia represent staff positions mapped to musical notes corresponding to finger positions on the fingerboard.

9. The device of claim 8, wherein the fingerboard represented by the background image is fretless.

10. The device of claim 1, wherein the background image comprises a representation of a keyboard and the sets of coded indicia represent staff positions mapped to musical notes corresponding to playing positions on the keyboard.

11. A lenticular imaging device comprising:
an image representing playing positions on a musical instrument;
a first set of coded indicia representing musical notes corresponding to the playing positions;
a second set of coded indicia representing staff positions corresponding to the musical notes;
a lenticular system positioned over the image, wherein the lenticular system is configured for selecting between a view of the first set of indicia with respect to the playing positions and a view of the second set of indicia with respect to the playing positions;
wherein the musical notes are mapped onto the staff positions based on a key of the musical instrument.

12. The device of claim 11, wherein the image represents playing positions comprising finger positions on a fretless fingerboard of the musical instrument.

13. The device of claim 12, wherein the image represents finger positions on a stringed instrument in the violin family.

14. The device of claim 11, wherein the image represents playing positions comprising finger positions on a fretboard of the musical instrument.

15. The device of claim 11, wherein the image represents playing positions on a key or bar layout, and wherein the musical notes are mapped to the staff positions based on the key or bar layout.

16. A graphical teaching device for a musical instrument, the device comprising:
a first image comprising alphanumeric indicia identifying musical notes corresponding to finger positions on the musical instrument;
a second image comprising staff indicia identifying the musical notes corresponding to the finger positions, wherein the musical notes are mapped one-to-one onto the staff indicia based on a key of the musical instrument; and
an imaging system for selecting between the first image with the alphanumeric indicia identifying the musical notes with respect to the finger positions and the second image with the staff indicia identifying the musical notes with respect to the finger positions.

17. The device of claim 16, wherein the first and second images represent finger positions in perspective on a fingerboard of the musical instrument.

18. The device of claim 17, wherein the fingerboard is fretless and further comprising markers to show tape locations on the fretless fingerboard.

19. The device of claim 16, wherein the first and second images represent finger positions on a keyboard of the musical instrument.

20. The device of claim 16, wherein the imaging system comprises a lenticular array configured for selecting between the first image and the second image based on a viewing angle, the viewing angle defined with respect to a plane of the teaching device.

21. A method for teaching music, comprising:
providing a graphical teaching device for a musical instrument, the device comprising:
a first image comprising alphanumeric indicia identifying musical notes corresponding to finger positions on the musical instrument;
a second image comprising staff indicia identifying the musical notes corresponding to the finger positions, wherein the musical notes are mapped one-to-one onto the staff indicia based on a key of the musical instrument; and
an imaging system for selecting between the first image with the alphanumeric indicia identifying the musical notes with respect to the finger positions and the second image with the staff indicia identifying the musical notes with respect to the finger positions; and
causing a pupil to selectively and alternatingly view at close time intervals the first image and the second image.

22. The method of claim 21, wherein the imaging system comprises a lenticular array.

23. The method of claim 21, wherein the finger positions represent finger positions on strings of the musical instrument.
